(19) United States
(12) Patent Application Publication
(10) Pub. No.: US 2026/0192856 A1
(43) Pub. Date: Jul. 9, 2026

(54) VEHICLE SYSTEMS AND CONTROL METHODS WITH DYNAMICALLY ADAPTIVE MODEL PREDICTIVE CONTROL FOR BIDIRECTIONAL MANEUVERS

(71) Applicant: GM GLOBAL TECHNOLOGY OPERATIONS LLC, Detroit, MI (US)

(72) Inventors: Ben MACCALLUM, Toronto (CA); Reza ZARRINGHALAM, Whitby (CA); Kin Man Michael WONG, Thornhill (CA); Rylee BOISSONEAU, Hamilton (CA)

(21) Appl. No.: 19/011,991

(22) Filed: Jan. 7, 2025

(51) Int. Cl. B62D 15/02; B62D 6/00

(52) U.S. Cl. CPC B62D 15/027; B62D 6/002; B62D 15/025

(57) ABSTRACT

A vehicle system includes a vehicle control module and a control module. The control module is configured to determine a desired speed profile and a target trajectory, identify a desired direction of travel for the vehicle based on at least one of the desired speed profile and the target trajectory, dynamically adapt, based on at least one of the desired speed profile and the target trajectory, a prediction control model to correspond to the desired direction of travel, and generate a steering angle command with the adapted prediction control model. The vehicle control module is configured control the vehicle based on the steering angle command to maneuver the vehicle along the target trajectory in the desired direction of travel. Other example vehicle systems and control method are also disclosed.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to vehicle systems and control methods with dynamically adaptive model predictive control for bidirectional maneuvers.

Vehicles, such as autonomous vehicles and semi-autonomous vehicles often include driver-assistance systems, such as parking assist, lane centering assist, lane keep assist, collision avoidance assist, etc. In such examples, the driver-assistance systems receive sensor data from one or more vehicle sensors (e.g., cameras, radar, etc.) and generate control commands (e.g., steering commands, velocity commands, etc.) for vehicle control. The driver-assistance systems may utilize a control approach with constant gains to generate the control commands. Sometimes, the driver-assistance systems may rely on a model predictive control (MPC) in which vehicle dynamics may be used to predict future vehicle behavior.

### SUMMARY

A vehicle system for dynamically controlling bidirectional maneuvers of a vehicle, includes one or more sensors configured to detect one or more objects external to a vehicle, a vehicle control module, and a control module in communication with the one or more sensors and the vehicle control module. The control module is configured to determine a desired speed profile and a target trajectory based on the detected objects, identify a desired direction of travel for the vehicle based on at least one of the desired speed profile and the target trajectory, dynamically adapt, based on at least one of the desired speed profile and the target trajectory, a prediction control model to correspond to the desired direction of travel, and generate a steering angle command with the adapted prediction control model. The vehicle control module is configured control the vehicle based on the steering angle command to maneuver the vehicle along the target trajectory in the desired direction of travel.

In other features, the control module is configured to determine a yaw rate reference for the vehicle, determine a rate of change of a heading error based on the yaw rate reference, and generate the steering angle command with the adapted prediction control model based on the rate of change of the heading error.

In other features, the control module is configured to determine at least one of forward and reverse segments for the vehicle and determine the yaw rate reference for the vehicle based on the at least one of the forward and reverse segments.

In other features, the target trajectory is a global frame target trajectory, and the control module is configured to convert the global frame target trajectory into a vehicle frame trajectory and determine the at least one of the forward and reverse segments based on the vehicle frame trajectory.

In other features, the control module is configured to determine a reference curvature for the vehicle based on the target trajectory and determine the yaw rate reference for the vehicle based on the reference curvature and a longitudinal velocity reference.

In other features, the control module is configured to latch a value of the longitudinal velocity reference to a defined value in response to the longitudinal velocity reference being less than the defined value.

In other features, the control module is configured to dynamically adapt at least one constraint for the adapted prediction control model based on at least one of the desired speed profile and the target trajectory.

In other features, the control module is configured to select a defined value for the at least one constraint based on at least one of the desired speed profile and the target trajectory.

In other features, the control module is configured to dynamically adapt at least one weight for the adapted prediction control model based on at least one of the desired speed profile and the target trajectory.

In other features, the control module is configured to select a defined value for the at least one weight based on at least one of the desired speed profile and the target trajectory.

In other features, the objects include at least one of a line marking and an object on a roadway.

In other features, the desired direction of travel is a forward direction of the vehicle or a reverse direction of the vehicle.

In other features, the prediction control model is stable during the forward direction of the vehicle and the reverse direction of the vehicle.

A vehicle system for dynamically controlling bidirectional maneuvers of a vehicle, includes one or more sensors configured to detect one or more objects external to a vehicle, a vehicle control module, and a control module in communication with the one or more sensors and the vehicle control module. The control module is configured to determine a desired speed profile and a target trajectory based on the detected objects, identify a desired direction of travel for the vehicle based on at least one of the desired speed profile and the target trajectory, dynamically adapt, based on at least one of the desired speed profile and the target trajectory, a prediction control model to correspond to the desired direction of travel, dynamically adapt at least one constraint and at least one weight for the adapted prediction control model, determine a yaw rate reference for the vehicle, determine a rate of change of a heading error based on the yaw rate reference, and generate a steering angle command with the adapted prediction control model based on the rate of change of the heading error. The vehicle control module is configured control the vehicle based on the steering angle command to maneuver the vehicle along the target trajectory in the desired direction of travel.

In other features, the control module is configured to determine a reference curvature for the vehicle based on the target trajectory and determine the yaw rate reference for the vehicle based on the reference curvature and a longitudinal velocity reference.

In other features, the control module is configured to latch a value of the longitudinal velocity reference to a defined value in response to the longitudinal velocity reference being less than the defined value.

A control method for dynamically controlling bidirectional maneuvers of a vehicle, includes detecting one or more objects external to a vehicle, determining a desired speed profile and a target trajectory based on the detected objects, identifying a desired direction of travel for the vehicle based on at least one of the desired speed profile and the target trajectory, dynamically adapting, based on at least one of the desired speed profile and the target trajectory, a prediction control model to correspond to the desired direction of travel, generating a steering angle command with the adapted prediction control model, and controlling the vehicle based on the steering angle command to maneuver the vehicle along the target trajectory in the desired direction of travel.

In other features, the control method further includes determining a reference curvature for the vehicle based on the target trajectory, determining a yaw rate reference for the vehicle based on the reference curvature and a longitudinal velocity reference, and determining a rate of change of a heading error based on the yaw rate reference.

In other features, generating the steering angle command with the adapted prediction control model includes generating the steering angle command with the adapted prediction control model based on the rate of change of the heading error.

In other features, the control method further includes latching a value of the longitudinal velocity reference to a defined value in response to the longitudinal velocity reference being less than the defined value.

In other features, the control method further includes dynamically adapting at least one constraint for the adapted prediction control model based on at least one of the desired speed profile and the target trajectory and dynamically adapting at least one weight for the adapted prediction control model based on at least one of the desired speed profile and the target trajectory.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a block diagram of an example a vehicle system for dynamically controlling bidirectional maneuvers of a vehicle, according to the present disclosure;

FIG. 2 is a diagram of an example scenario in which the vehicle of FIG. 1 utilizes a parking assist system to park the vehicle in a parking spot, according to the present disclosure;

FIG. 3 is a block diagram of one example implementation of a control module in the vehicle system of FIG. 1, according to the present disclosure;

FIGS. 4-5 are block diagrams of example reference frames showing vehicle parameters for use with the control module of FIG. 3, according to the present disclosure;

FIG. 6 is a diagram of an example parking sequence in which a vehicle is controlled to park in a target location by making reverse and forward maneuvers, according to the present disclosure; and

FIGS. 7-9 are flowcharts of example control processes for dynamically controlling bidirectional maneuvers of a vehicle, according to the present disclosure.

In the drawings, reference numbers may be reused to identify similar and/or identical elements.

### DETAILED DESCRIPTION

Vehicles, such as autonomous vehicles and semi-autonomous vehicles often include driver-assistance systems (e.g., advanced driver assistance systems), such as parking assist, lane centering assist, lane keep assist, collision avoidance assist, etc. In such examples, the driver-assistance systems may utilize a control approach with constant or static gains to generate the control commands based on sensor data or utilize a model predictive control (MPC) in which vehicle dynamics may be used to predict future vehicle behavior. When MPC is used, each driver-assistance system uses a different static, predictive model with separate control logics for vehicle control in one direction (e.g., forward direction or rearward direction).

The vehicle systems and control methods according to the present disclosure leverage a MPC strategy for controlling both forward and reverse driving maneuvers, thereby enabling precise and model-based control in both forward and rearward directions. For example, the vehicle systems and control methods herein utilize a MPC plant model designed to dynamically adapt its structure and parameters when the direction of travel switches between forward and rearward motion. With this dynamic adaptation, the MPC plant model can transform into a format that is stable in extremely low vehicle velocities and when the vehicle velocity vector undergoes a sign change (e.g., crosses a zero value). With this state-of-the-art model design, a single control structure can be employed to support multiple (and sometimes all) advanced driver assistance systems (ADAS) features in both driving directions with a streamlined software architecture and calibration strategy. As such, alternating between forward and reverse motion may be achieved while maintaining steering control by adapting the model and bounding on a longitudinal speed reference to maintain stability through zero-speed crossing, as further explained herein.

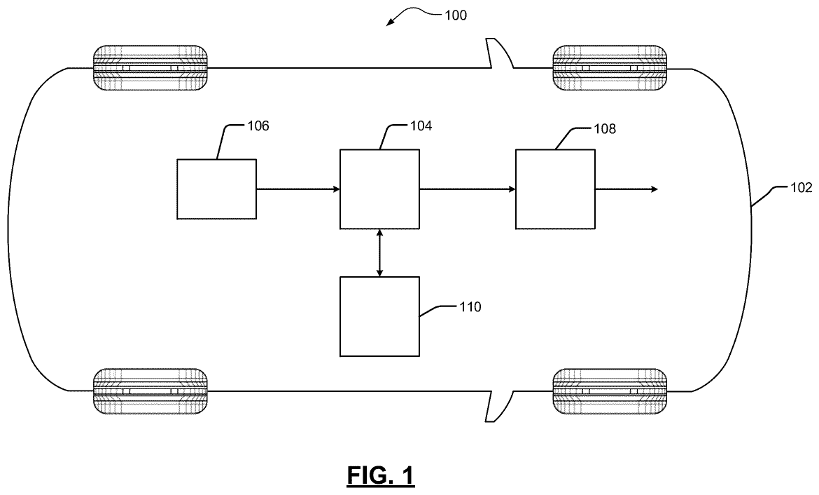

Referring now to FIG. 1, a block diagram of an example vehicle system 100 is presented for dynamically controlling bidirectional maneuvers of a vehicle 102. As shown in FIG. 1, the vehicle system 100 generally includes a control module 104, one or more sensors 106, a vehicle control module 108, and a memory circuit 110. In the example of FIG. 1, the memory circuit 110 may be external to the control module 104 as shown or internal to the control module 104 if desired. Although FIG. 1 illustrates the vehicle system 100 as including specific dedicated modules, it should be appreciated that one or more other modules may be employed if desired. For example, any combination of the modules (e.g., the control module 104 and the vehicle control module 108) and/or the functionality thereof may be integrated into a single module or multiple different modules.

The vehicle system 100 of FIG. 1 may be employable in any suitable vehicle, such as an autonomous vehicle, a semi-autonomous vehicle, etc. Additionally, the vehicle system 100 may be applicable to electric vehicles (e.g., a pure electric vehicle, a plug-in hybrid electric vehicle, etc.) and internal combustion engine (ICE) vehicles. In the example of FIG. 1, the vehicle system 100 is employed in the vehicle 102, which may be an autonomous vehicle, a semi-autonomous, etc.

In the example of FIG. 1, the sensor(s) 106, the vehicle control module 108, and the memory circuit 110 are in communication with the control module 104. In such examples, the control module 104 may receive and/or transmit signals, data, etc. from and/or to each of the sensor(s) 106, the vehicle control module 108, and the memory circuit 110. The internal vehicle modules may receive and/or transmit signals between each other via a network, such as a controller area network (CAN).

The sensor(s) 106 may be any suitable device for detecting objects external to the vehicle 102. In such examples, the sensor(s) 106 may generally be part of a perception module for providing sensor data to the control module 104. For example, the sensor(s) 106 may include cameras (e.g., a front camera module, a rear camera module, side camera modules, etc.), radar sensors, etc. that detect objects, such as line markings (e.g., parking space lines, roadway lane lines, etc.), objects on the roadway, etc. In some examples, the objects on the roadway may include, for example, signs (e.g., traffic signs, parking signs, etc.), curbs (e.g., parking stones, roadside curbs, etc.), other vehicles, individuals (e.g., a person walking along the roadway, a person walking in a parking lot, etc.), etc.

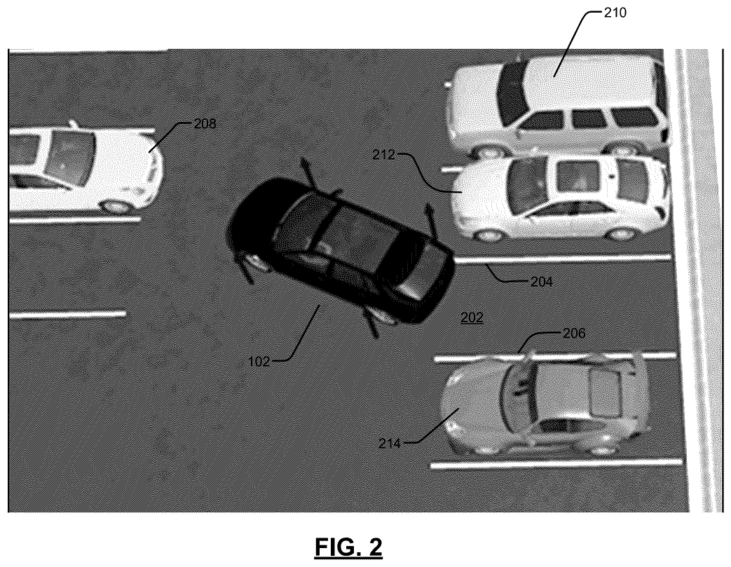

The vehicle system 100 of FIG. 1 generally functions to enable dynamic adaptability of a MPC plant model, as further explained below. In doing so, the adaptable MPC plant model can be employed to control the vehicle 102 for both forward and reverse driving maneuvers. Such features may be beneficially for various driver-assistance systems. For example, FIG. 2 depicts a scenario in which the vehicle 102 is utilizing a parking assist system for parking the vehicle 102 in a parking spot 202. As shown, the parking spot 202 is defined by parking space lines 204, 206, and is near other vehicles 208, 210, 212, 214. In such examples, the vehicle system 100 of FIG. 1 can detect the parking space lines 204, 206 and the nearby vehicles 208, 210, 212, 214. Then, based on the detected objects, the vehicle system 100 can generate one or more speed profiles and target trajectories for making necessary maneuvers to control the vehicle 102 to move into the parking spot 202 with the parking assist system, as further explained herein. In some examples, the maneuvers may include one or more forward and reverse driving maneuvers to ensure the vehicle 102 enters the parking spot 202 without hitting the other vehicles 208, 210, 212, 214.

For example, and with continued reference to FIG. 1, the control module 104 initially receives sensor data from the sensor(s) 106. With this sensor data, the control module 104 may detect objects external to the vehicle 102, such as the line markings, roadway objects, etc.

Then, the control module 104 determines a desired speed profile and a target trajectory. In such examples, the desired speed profile and the target trajectory may be determined based on the detected objects. In such examples, the desired speed profile and the target trajectory are determined to enable the vehicle 102 to make one or more maneuvers (e.g., move forward and to the left, move rearwards and to the right, etc.).

In various embodiments, the target trajectory represents a reference path for the vehicle 102 to follow to ensure the vehicle 102 reaches a desired location. In such examples, the target trajectory may include a set of coordinate points representing the maneuver(s) (e.g., a complete set of maneuvers) necessary to reach the desired location while avoiding the detect objects. In various embodiments, the set of coordinate points may correspond to a center of a lane, a center of a vehicle path in a parking lot, etc.

Additionally, the speed profile represents a longitudinal speed profile for the vehicle 102 in the present time and in the future. For example, as the vehicle 102 is moving, the longitudinal speed may change over time. For instance, the longitudinal speed may be 2 km/hr at a first segment (of the target trajectory) indicating forward movement of the vehicle 102, zero (0) at a second segment in the future indicating the vehicle 102 will be stopped, and then −1 km/hr at a third segment in the future indicating rearward movement of the vehicle 102. In other examples, the longitudinal speeds may be all positive values (e.g., indicating forward movements) or all negative values (e.g., indicating rearward movements) if desired.

Then, the control module 104 may identify a desired direction of travel for the vehicle 102. For example, the direction of travel may be determined based on at least one of the desired speed profile and the target trajectory. For instance, if the speed profile indicates a negative longitudinal speed, such as at a future segment or point of the target trajectory, the control module 104 may identify the direction of travel will be rearward. If, however, the speed profile indicates a positive longitudinal speed, such as at a future segment or point of the target trajectory, the control module 104 may identify the direction of travel will be forward. In other examples, the control module 104 may identify the direction of travel based on a sequence of points for the target trajectory.

Next, the control module 104 dynamically adapts a prediction control model to correspond to the desired direction of travel. For example, the control module 104 can adapt the prediction control model in real time based on at least one of the desired speed profile and the target trajectory. In such examples, when a switch in direction of travel is identified based on the desired speed profile and/or the target trajectory, the control module 104 can adapt the structure and parameters of the prediction control model for the new direction of travel. For example, and as further explained below, the control module 104 can change one or more signs associated with functions in the model based on the change in direction of travel.

In various embodiments, the prediction control model may be stored in the memory circuit 110. In such examples, the control module 104 may receive the prediction control model (e.g., a default model) from the memory circuit 110. Then, the control module 104 can adapt the prediction control model as necessary for a switch in direction of travel.

Then, after the prediction control model is adapted for the direction of travel, the control module 104 can generate control commands using the adapted prediction control model. For example, the control module 104 may generate a steering angle command with the adapted prediction control model, and then transmit the steering angle command (along with other possible control commands) to the vehicle control module 108.

The vehicle control module 108 then controls the vehicle 102 based on the steering angle command to maneuver the vehicle 102 along the target trajectory in the desired direction of travel. For example, the vehicle control module 108 may generate one or more control signals for one or more actuators, such as a steering wheel actuator, a road wheel actuator, etc. to apply an appropriate amount of torque to a steering column or a steering rack to move the steering wheel or the road wheels to a desired position. This, in turn, causes the vehicle heading to change as the vehicle 102 moves.

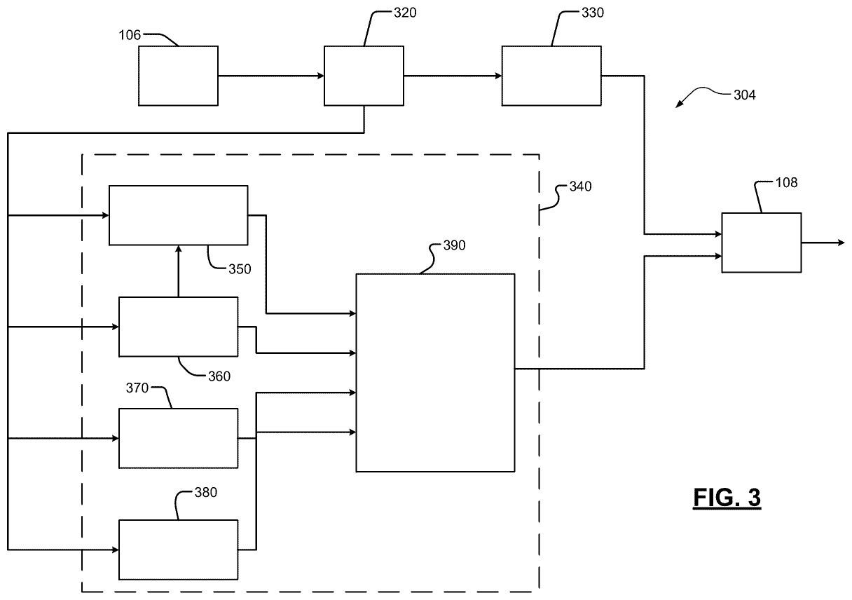

The control module 104 of FIG. 1 may be implemented in any suitable manner to adapt the prediction control model. For example, FIG. 3 depicts one example representation of a control module 304 that may be implemented as or part of the control module 104 of FIG. 1. As shown in FIG. 3, the control module 304 generally includes a planning module 320, a longitudinal control module 330, and a lateral control module 340. In this example, the planning module 320 receives sensor data from the sensor(s) 106 of FIG. 1 or detected external objects as explained above, and the longitudinal control module 330 and the lateral control module 340 transmit control commands to the vehicle control module 108 for controlling the vehicle 102.

In the example of FIG. 3, the lateral control module 340 includes a plant model adaptation module 350, a reference path segmentation module 360, a constraint adaptation module 370, a weight adaptation module 380, and a model predictive control (MPC) module 390. As shown, the plant model adaptation module 350, the reference path segmentation module 360, the constraint adaptation module 370, and the weight adaptation module 380 each receive one or more inputs from the planning module 320 and provide one or more outputs to the MPC module 390, as further explained below.

In the example control module 304 of FIG. 3, the planning module 320 determines a desired speed profile and a target trajectory. For example, the planning module 320 can determine the desired speed profile and the target trajectory based on sensor data from the sensor(s) 106. In such examples, the planning module 320 may detect external objects based on the sensor data. In other examples, the planning module 320 may receive the detected objects (e.g., data representing the objects). In either case, the planning module 320 determines a desired speed profile and a target trajectory based on the detected objects, as explained above.

The planning module 320 then provides the desired speed profile and/or the target trajectory to other modules in the control module 304. For example, the planning module 320 may transmit the desired speed profile to the longitudinal control module 330. Additionally, the planning module 320 may transmit the desired speed profile and/or the target trajectory to the lateral control module 340, and more specifically, to the plant model adaptation module 350, the reference path segmentation module 360, the constraint adaptation module 370, and the weight adaptation module 380.

The plant model adaptation module 350 generally adapts a prediction control model (e.g., a vehicle dynamics model) based on the desired speed profile and/or the target trajectory. For example, the plant model adaptation module 350 may identify a desired direction of travel for the vehicle 102 based on at least one of the desired speed profile and the target trajectory. Then, based on this direction of travel, the plant model adaptation module 350 can dynamically adapt the prediction control model.

For example, the plant model adaptation module 350 may generate a first set of functions for rearward movement and a second set of functions for forward movement for a prediction control model (e.g., a linear bicycle model, etc.). In the example of FIG. 3, the set of functions may differ by one or more sign changes associated with the functions. For example, Equations (1)-(5) below represent functions for rearward (or reverse) movement.

In Equations (1)-(5),

$${e}_{y}^{P R}$$

represents a lateral error at a point or rotation;

$${V}_{y}^{r}$$

represents a reverse-frame lateral velocity reference at a center of center of gravity (CG) of the vehicle 102; e_{ψ} represents a heading error; ω_{z} represents a yaw rate; δ_{f} represents a measured front road wheel angle; δ_{f,cmd} represents a commanded front road wheel angle;

$${V}_{x}^{r}$$

represents a reverse-frame longitudinal velocity reference at the CG; l_{f} represents a CG to front axle distance; lᵣ represents a CG to rear axle distance; l_{ARS} represents a rear axle to point of rotation distance due to active rear steering; C_{f} represents a front tire cornering stiffness; Cᵣ represents a rear tire cornering stiffness;

$${F}_{y f}^{r}$$

represents a front tire lateral force (reverse frame);

$${F}_{y r}^{r}$$

represents a rear tire lateral force (reverse frame); m represents a vehicle mass; I_{zz} represents a yaw moment of inertia; and τ represents a steering actuator delay time constant. In this example, the yaw rate (ω_{z}) may be determined and provided by the reference path segmentation module 360, as further explained below.

$${\dot{e}}_{y}^{P R} = {\dot{e}}_{y} - ( {l}_{r} - {l}_{A R S} ) {ω}_{z} = - {V}_{y}^{r} - {V}_{x}^{r} {e}_{ψ} - {l}_{r} {ω}_{z} \qquad Equation ( 1 )$$

$$Equation ( 2 )$$

$${\dot{V}}_{y}^{r} = \frac{\sum {F}_{y}^{r}}{m} - {V}_{x}^{r} {ω}_{z} = \frac{1}{m} [ {F}_{y f}^{r} + {F}_{y r}^{r} ] - {V}_{x}^{r} {ω}_{z} = \frac{1}{m} [ {C}_{f} ( - \frac{{V}_{y}^{r} - {l}_{f} {ω}_{z}}{{V}_{x}^{r}} + {δ}_{f} ) + {C}_{r} ( - \frac{{V}_{y}^{r} + {l}_{r} {ω}_{z}}{{V}_{x}^{r}} + {δ}_{r} ) ] - {V}_{x}^{r} {ω}_{z}$$

$${\dot{e}}_{ψ} = {ω}_{z} - {\dot{ψ}}_{r e f} \qquad Equation ( 3 )$$

$$Equation ( 4 )$$

$${\dot{ω}}_{z} = \frac{\sum M}{{I}_{zz}} = \frac{- {F}_{y f}^{r} {l}_{f} + {F}_{y r}^{r} {l}_{r}}{{I}_{zz}} = \frac{1}{{I}_{zz}} [ - {C}_{f} {l}_{f} ( - \frac{{V}_{y}^{r} - {l}_{f} {ω}_{z}}{{V}_{x}^{r}} + {δ}_{f} ) + {C}_{r} {l}_{r} ( - \frac{{V}_{y}^{r} + {l}_{r} {ω}_{z}}{{V}_{x}^{r}} + {δ}_{r} ) ]$$

$${\dot{δ}}_{f} = \frac{{δ}_{f , c m d} - {δ}_{f}}{τ} \qquad Equation ( 5 )$$

Then, the plant model adaptation module 350 may generate a matrix in accordance with Equation (6) below for representing the prediction control model for rearward movement. In this example, vectors for the forward-frame longitudinal velocity reference

$$( {V}_{x}^{f} )$$

and the forward-frame lateral velocity reference

$$( {V}_{y}^{f} )$$

may be substituted back into a state-space model. This matrix may then be provided to the MPC module 390 for rearward movement.

$$Equation ( 6 )$$

$$\dot{x} = [ \begin{matrix}{\dot{e}}_{y}^{PR} \\ {\dot{V}}_{y} \\ {\dot{e}}_{ψ} \\ {\dot{ω}}_{z} \\ {\dot{δ}}_{f}\end{matrix} ] = [ \begin{matrix}0 & 1 & {V}_{x} & - ( {l}_{r} - {l}_{ARS} ) & 0 \\ 0 & + \frac{{C}_{f} + {C}_{r}}{{mV}_{x}} & 0 & - {V}_{x} + \frac{{C}_{f} {l}_{f} - {C}_{r} {l}_{r}}{{mV}_{x}} & - \frac{{C}_{f}}{m} \\ 0 & 0 & 0 & 0 & 0 \\ 0 & + \frac{{C}_{f} {l}_{f} - {C}_{r} {l}_{r}}{{I}_{zz} {V}_{x}} & 0 & + \frac{{C}_{f} {l}_{f}^{2} - {C}_{r} {l}_{r}^{2}}{{I}_{zz} {V}_{x}} & - \frac{{C}_{f} {l}_{f}}{{I}_{zz}} \\ 0 & 0 & 0 & 0 & - \frac{1}{{t}_{filt}}\end{matrix} ] [ \text{} \begin{matrix}{e}_{y} \\ {V}_{y} \\ {e}_{ψ} \\ {ω}_{z} \\ {δ}_{f}\end{matrix} ] + [ \begin{matrix}0 \\ 0 \\ 0 \\ 0 \\ \frac{1}{{t}_{filt}}\end{matrix} ] {δ}_{f , cmd} + [ \begin{matrix}{V}_{yd} \\ {a}_{yd} \\ {ω}_{zd} - {\dot{ψ}}_{r} \\ {R}_{zd} \\ 0\end{matrix} ]$$

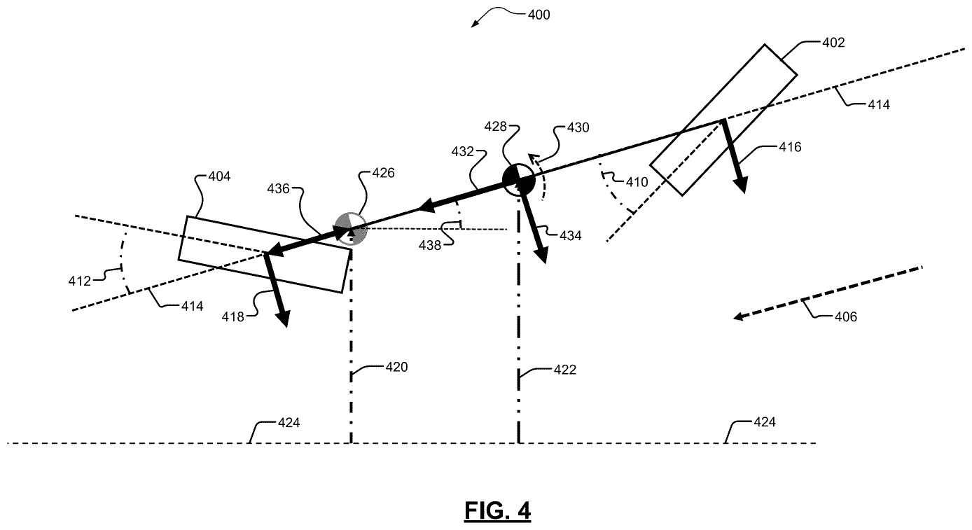

FIG. 4 depicts one example representation of a reference frame 400 for identifying parameters associated with Equations (1)-(5) with respect to the vehicle 102 having a front wheel 402 and a rear wheel 404 when the vehicle 102 is planning a rearward movement, as indicated by dashed line 406. In FIG. 4, reference numbers 410, 412 represent a measured front road wheel angle (δ_{f}) and a measured rear road wheel angle (δᵣ), respectively, relative to a reference center line 414 extending through center points of the wheels 402, 404. Reference numbers 416, 418 represent a front tire lateral force

$$( {F}_{y f}^{r} )$$

and the rear tire lateral force

$$( {F}_{y r}^{r} ) ,$$

respectively. Reference number 420 represents a lateral error

$$( {e}_{y}^{P R} )$$

at a point of rotation 426 relative to a reference path 424 (e.g., a target trajectory), and reference number 422 represents a lateral error (e_{y}) at a center of gravity (CG) 428 relative to the reference path 424. Reference number 430 represents a yaw rate (ω_{z}). Reference numbers 432, 434 represent a reverse-frame longitudinal velocity reference

$$( {V}_{x}^{r} )$$

and a reverse-frame lateral velocity reference

$$( {V}_{y}^{r} )$$

at the CG 428, respectively. Reference number 436 represents a distance (l_{ARS}) between a rear axle and the point of rotation 426 due to active rear steering, and refence number 438 represents a heading error (e_{ψ}) relative to the reference center line 414.

If, however, the vehicle 102 has plans to move forward, the reference frame 400 is rotated 180 degrees. With this rotation, the longitudinal velocity reference

$$( {V}_{x}^{r} )$$

and the lateral velocity reference

$$( {V}_{y}^{r} )$$

at the CG 428 (represented by the reference numbers 432, 434) are now represented by a forward-frame longitudinal velocity reference

$$( - {V}_{x}^{f} )$$

and a forward-frame lateral velocity reference

$$( - {V}_{y}^{f} ) .$$

The plant model adaptation module 350 then can adapt the prediction control model to reflect this rotation.

For example, Equations (7) and (8) below represent functions for forward movement. In this example, Equations (7) and (8) are substantially similar to Equations (2) and (4) above, but with some sign changes.

$$Equation ( 7 )$$

$${\dot{V}}_{y}^{f} = \frac{\sum {F}_{y}^{f}}{m} - {V}_{x}^{f} {ω}_{z} = \frac{1}{m} [ {F}_{y f}^{f} + {F}_{y r}^{f} ] - {V}_{x}^{f} {ω}_{z} = \frac{1}{m} [ {C}_{f} ( - \frac{{V}_{y}^{r} + {l}_{f} {ω}_{z}}{{V}_{x}^{r}} + {δ}_{f} ) + {C}_{r} ( - \frac{{V}_{y}^{r} - {l}_{r} {ω}_{z}}{{V}_{x}^{r}} + {δ}_{r} ) ] - {V}_{x}^{r} {ω}_{z}$$

$$Equation ( 8 )$$

$${\dot{ω}}_{z} = \frac{\sum M}{{I}_{zz}} = \frac{{F}_{y f}^{f} {l}_{f} - {F}_{y r}^{f} {l}_{r}}{{I}_{zz}} = \frac{1}{{I}_{zz}} [ {C}_{f} {l}_{f} ( - \frac{{V}_{y}^{f} - {l}_{f} {ω}_{z}}{{V}_{x}^{f}} + {δ}_{f} ) - {C}_{r} {l}_{r} ( - \frac{{V}_{y}^{f} - {l}_{r} {ω}_{z}}{{V}_{x}^{f}} + {δ}_{r} ) ]$$

Then, the plant model adaptation module 350 may generate a matrix in accordance with Equation (9) below for representing the prediction control model for forward movement. In this example, the matrix in Equation (9) is substantially similar to the matrix in Equation (6) above but with some sign changes. This matrix may then be provided to the MPC module 390 for forward movement.

$$Equation ( 9 )$$

$$\dot{x} = [ \begin{matrix}{\dot{e}}_{y}^{PR} \\ {\dot{V}}_{y} \\ {\dot{e}}_{ψ} \\ {\dot{ω}}_{z} \\ {\dot{δ}}_{f}\end{matrix} ] = [ \begin{matrix}0 & 1 & {V}_{x} & - ( {l}_{r} - {l}_{ARS} ) & 0 \\ 0 & - \frac{{C}_{f} + {C}_{r}}{{mV}_{x}} & 0 & - {V}_{x} - \frac{{C}_{f} {l}_{f} - {C}_{r} {l}_{r}}{{mV}_{x}} & + \frac{{C}_{f}}{m} \\ 0 & 0 & 0 & 1 & 0 \\ 0 & - \frac{{C}_{f} {l}_{f} - {C}_{r} {l}_{r}}{{I}_{zz} {V}_{x}} & 0 & - \frac{{C}_{f} {l}_{f}^{2} + {C}_{r} {l}_{r}^{2}}{{I}_{zz} {V}_{x}} & + \frac{{C}_{f} {l}_{f}}{{I}_{zz}} \\ 0 & 0 & 0 & 0 & - \frac{1}{{t}_{filt}}\end{matrix} ] [ \text{} \begin{matrix}{e}_{y} \\ {V}_{y} \\ {e}_{ψ} \\ {ω}_{z} \\ {δ}_{f}\end{matrix} ] + [ \begin{matrix}0 \\ 0 \\ 0 \\ 0 \\ \frac{1}{{t}_{filt}}\end{matrix} ] {δ}_{f , cmd} + [ \begin{matrix}{V}_{yd} \\ {a}_{yd} \\ {ω}_{zd} - {\dot{ψ}}_{r} \\ {R}_{zd} \\ 0\end{matrix} ]$$

With continued reference to FIG. 3, the reference path segmentation module 360 may be employed for multiple purposes. For example, the reference path segmentation module 360 converts a global frame target trajectory from the planning module 320 to a vehicle frame trajectory and generates forward or reverse segments depending on vehicle direction of travel. Additionally, the reference path segmentation module 360 computes desired vehicle states (e.g., reference yaw rate, etc.) with respect to the segmented vehicle frame trajectory that is required by the MPC module 390. This allows the MPC to follow the forward and reverse path accurately.

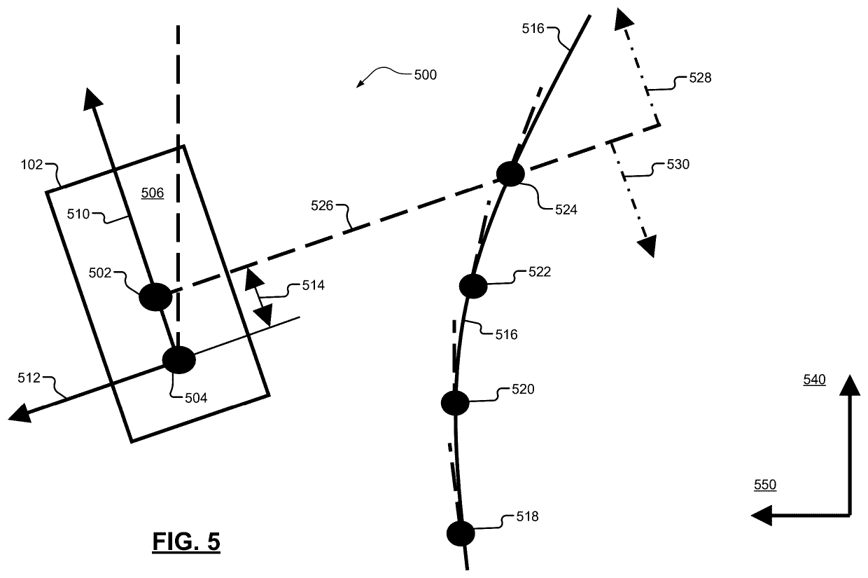

For example, FIG. 5 depicts a diagram 500 of the vehicle 102 of FIG. 1, in which a vehicle target trajectory is segmented and transformed from a global frame to forward and/or reverse segments in a zero sideslip, vehicle frame. In this example, the vehicle 102 is travelling in a longitudinal direction (X_{ego}), which is represented by arrow 510 (e.g., a longitudinal axis 510). As shown in FIG. 5, reference numbers 502, 504 represent the zero sideslip point and a rear axle of the vehicle 102, respectively. Reference number 506 represents the vehicle's heading angle

$$( {Θ}_{v e h}^{g} )$$

the global frame (e.g., the reference frame provided by the planning module 320). The lateral direction of travel (Y_{ego}) of the vehicle 102 is represented by arrow 512. Reference number 514 represents a distance (l_{ARS}) between the rear axle 504 and the zero sideslip point 502.

Additionally, in FIG. 5, the determined target trajectory (provided by the planning module 320) is shown as line 516, and includes a set of coordinate points 518, 520, 522, 524 in the global frame. In this example, each point has a coordinate set of Xᵢ, Yᵢ, θᵢ, where X is the longitudinal value along the axis 540 (e.g., the global frame X-axis) for that point, Y is the lateral value along the axis 550 for that point (e.g., the global frame Y-axis), and θ is the vehicle's heading angle 506 for that point. For example, the point 518 has coordinates X₀, Y₀, θ₀, the point 520 has coordinates X₁, Y₁, θ₁, and so on. Each point 518, 520, 522, 524 in the global frame along the target trajectory is segmented into forward and/or reverse segments in the zero sideslip, vehicle frame. As shown, a line 526 is perpendicular to the vehicle's longitudinal axis 510, and traverses between the zero sideslip point 502 of the vehicle 102 and the point 524, indicating a current position of the vehicle 102 along the target trajectory. Segments along the target trajectory above the line 526 represent forward segments as indicated by dashed arrow 528, while segments along the target trajectory below the line 526 represent reverse segments as indicated by dashed arrow 530.

Equations (10)-(14) below represent an example transformation of the target trajectory in the global frame to forward and/or reverse segments in the zero sideslip, vehicle frame. For example, Equation (10) is employed to adjust a pose

$$( {x}_{veh}^{g} , {y}_{veh}^{g} , {Θ}_{v e h}^{g} )$$

of the vehicle (ego) 102 based on a lever arm distance (l_{ARS}) to obtain adjusted points

$$( {x}_{v e h}^{A R S} , {y}_{v e h}^{A R S} ) .$$

Then, Equation (11) is employed to convert each path point 518, 520, 522, 524 with coordinates Xᵢ, Yᵢ, to zero sideslip vehicle frame points

$$( {x}_{i}^{e g o} , {y}_{i}^{e g o} ) .$$

Next, Equation (12) represents that all longitudinal points

$${x}_{i}^{e g o}$$

greater than or equal to zero in the zero sideslip vehicle frame points

$$( {x}_{i}^{e g o} , {y}_{i}^{e g o} )$$

are forward segments, while Equation (13) represents that all longitudinal points

$${x}_{i}^{e g o}$$

less than or equal to zero in the zero sideslip vehicle frame points

$$( {x}_{i}^{e g o} , {y}_{i}^{e g o} )$$

are reverse segments.

$$[ \begin{matrix}{x}_{v e h}^{A R S} \\ {y}_{v e h}^{A R S}\end{matrix} ] = [ \begin{matrix}{x}_{v e h}^{g} \\ {y}_{v e h}^{g}\end{matrix} ] + [ \begin{matrix}{l}_{A R S}^{e g o} * cos {Θ}_{v e h}^{g} \\ {l}_{A R S}^{e g o} * sin {Θ}_{v e h}^{g}\end{matrix} ] \qquad Equation ( 10 )$$

$$[ \begin{matrix}{x}_{i}^{e g o} \\ {y}_{i}^{e g o}\end{matrix} ] = [ \begin{matrix}cos {Θ}_{v e h}^{g} & sin {Θ}_{v e h}^{g} \\ - sin {θ}_{v e h}^{g} & cos {Θ}_{v e h}^{g}\end{matrix} ] ( [ \begin{matrix}{x}_{i}^{G} \\ {y}_{i}^{G}\end{matrix} ] - [ \begin{matrix}{x}_{v e h}^{A R S} \\ {y}_{v e h}^{A R S}\end{matrix} ] ) \qquad Equation ( 11 )$$

$$( {x}_{i}^{e g o} , {y}_{i}^{e g o} ) ∀ {x}_{i}^{e g o} \geq 0 \qquad Equation ( 12 )$$

$$( {x}_{i}^{e g o} , {y}_{i}^{e g o} ) ∀ {x}_{i}^{e g o} \leq 0 \qquad Equation ( 13 )$$

With continued reference to FIG. 3, the reference path segmentation module 360 may then determine a desired (or reference) yaw rate for the vehicle 102 for forward and reverse segments along the target trajectory based on at least some of the set of points

$$( {x}_{i}^{e g o} , {y}_{i}^{e g o} )$$

generated from Equations (12) and (13) above. The

For example, the reference path segmentation module 360 may implement Equations (14)-(16) below to determine or otherwise compute a reference heading angle, a reference curvature, and then a reference yaw rate for both the forward and reverse segments. Specifically, in Equation (14), the reference heading angle (ref) is determined based on a change in lateral values and a change in longitudinal values of sets of points

$$( {x}_{i}^{e g o} , {y}_{i}^{e g o} ) .$$

Then, in Equation (15), the reference curvature (ρ_{ref}) is determined based on a change in the reference heading angle (from Equation (14)) and a change in longitudinal values of sets of points

$$( {x}_{i}^{e g o} , {y}_{i}^{e g o} ) .$$

In Equation (16), the reference yaw rate (\dot{ψ}_{ref}) is determined based on the reference curvature (from Equation (15)) and the longitudinal velocity reference (Vₓ).

$${ψ}_{r e f} = \frac{Δ y}{Δ x} \qquad Equation ( 14 )$$

$${ρ}_{r e f} = \frac{Δ {ψ}_{r e f}}{Δ x} = \frac{Δ y}{Δ {x}^{2}} \qquad Equation ( 15 )$$

$${\dot{ψ}}_{r e f} = {V}_{x} * {ρ}_{r e f} \qquad Equation ( 16 )$$

In various embodiments, the reference path segmentation module 360 may then determine a heading error and a rate of change of the heading error for the vehicle 102. For example, the reference path segmentation module 360 may implement Equation (17) below to determine the heading error (e_{ψ}) and Equation (18) below to determine the rate of change of the heading error (ė_{ψ}) for either the forward segments or the reverse segments. Specifically, in Equation (17), the heading error (e_{ψ}) is determined based on a heading (ψ) and the reference heading angle (ψ_{ref}) from Equation (14) above. In this example, the heading (w) may be a measured value or computed through conventional methods. Then, in Equation (18), the rate of change of the heading error (ė_{ψ}) is determined based on a yaw rate (ω_{z}) and the reference yaw rate (\dot{ω}_{ref}) from Equation (16) above. In this example, the yaw rate (ω_{z}) may be a measured value or computed through conventional methods.

$${e}_{ψ} = ψ - {ψ}_{ref} \qquad Equation ( 17 )$$

$${\dot{e}}_{ψ} = {w}_{z} - {\dot{ψ}}_{ref} = {w}_{z} - ( {V}_{x} * {ρ}_{r e f} ) \qquad Equation ( 18 )$$

Then, in various embodiments, the reference path segmentation module 360 may provide some or all of the determined data to the MPC module 390 for vehicle control. For example, the reference path segmentation module 360 may provide the reference heading angle, the reference curvature, the reference yaw rate, the heading error, and/or the rate of change of the heading error for the appreciate forward or reverse segment(s).

In various embodiments, the longitudinal velocity reference (Vₓ) herein may be zero or cross zero (0) when, for example, the vehicle 102 stops, a change in direction occurs, etc. In other words, the longitudinal speed profile of the vehicle 102 may decrease from a positive value indicating the vehicle 102 will slow down while moving forward or increase from a negative value indicating the vehicle 102 will slow down while moving rearward. If the longitudinal velocity reference (Vₓ) reaches zero, the prediction control model may become unstable. This is due to, for example, the model implementing functions with the longitudinal velocity reference (Vₓ) in the denominator (e.g., division by zero).

To address such issues, the control module 304 may latch a value of the longitudinal velocity reference (Vₓ) to a defined value when it approaches zero. For example, in response to the longitudinal velocity reference (Vₓ) being less than a defined value, the control module 304 may latch a value of the longitudinal velocity reference (Vₓ) to that defined value. In such examples, the defined value may be a calibratable value depending on various factors, such as the maneuver application (e.g., parking assistance, etc.), model stability, etc. As examples only, the defined value may be +/−0.1 m/s, +/−0.5 m/s, +/−0.7 m/s, +/−1 m/s, +/−2 m/s, or another suitable value.

With continued reference to FIG. 3, constraints and/or weights for the adapted prediction control model may be adapted as well in various embodiments. For example, depending on the direction of travel (forward or reverse), the model constraints and/or weights may be altered to provide accurate path tracking in either direction. In various embodiments, such adaptation of the constraints and/or weights may take place in real time.

For example, the constraint adaptation module 370 of FIG. 3 may dynamically adapt at least one constraint for the adapted prediction control model provided to the MPC module 390 for vehicle control. In such examples, the constraint(s) may be adapted based on the desired speed profile and/or the target trajectory received from the planning module 320. Additionally, in some examples, the constraint(s) may be adjusted to any suitable value(s). For example, in some embodiments, the constraint adaptation module 370 may set a defined, calibratable value for a constraint based on the desired speed profile and/or the target trajectory (e.g., whether the longitudinal speed is high or low, whether the direction is forward or reverse, etc.). Then, the constraint adaptation module 370 may output the adapted constraint(s) to the MPC module 390.

Likewise, the weight adaptation module 380 of FIG. 3 may dynamically adapt at least one weight for the adapted prediction control model. In such examples, the weight(s) may be adapted based on the desired speed profile and/or the target trajectory received from the planning module 320. Additionally, similar to adaptable constraint(s), the weight(s) may be adjusted to any suitable value(s). For example, the weight adaptation module 380 may set a defined, calibratable value for a weight based on the desired speed profile and/or the target trajectory (e.g., whether the longitudinal speed is high or low, whether the direction is forward or reverse, etc.). Then, the weight adaptation module 380 may output the adapted weight(s) to the MPC module 390.

With continued reference to FIG. 3, the MPC module 390 then may implement the adapted prediction control model from the plant model adaptation module 350 for vehicle control. Specifically, the MPC module 390 may generate a steering angle command with the adapted prediction control model having optionally adapted constraints and/or weights. In such examples, the steering angle command may be generated based on the data (e.g., the rate of change of the heading error, etc.) provided by the reference path segmentation module 360. The MPC module 390 then provides the steering angle command to the vehicle control module 108.

In various embodiments, the MPC module 390 may implement the adapted prediction control model to solve a cost function. For example, the cost function may be solved to determine the desired steering angle command. For instance, the adapted prediction control model may find the optimal value of the steering angle command to minimize a result of the cost function. In such examples, the cost function may be suitable function.

The vehicle control module 108 can then control the vehicle 102 based on the steering angle command from the MPC module 390 and a longitudinal speed command from the longitudinal control module 330. For example, the vehicle control module 108 may generate one or more control signals for controlling maneuver(s) of the vehicle 102 along the target trajectory in the desired direction of travel, as explained above.

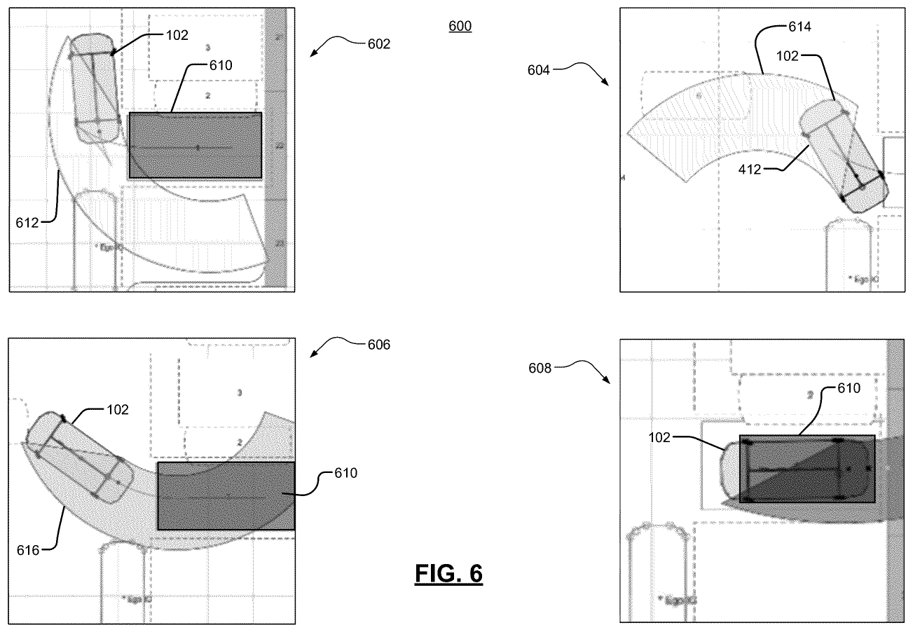

For example, the vehicle 102 may be controlled to make both reverse maneuvers and forward maneuvers in a sequence. This may be useful in a parking assist system. For instance, FIG. 6 depicts an example parking sequence 600 in which the vehicle 102 is controlled to park in a target location 610. Specifically, at step 602, the vehicle 102 is controlled to move along a target trajectory 612 in a reverse direction. Then, at step 604, the vehicle 102 is controlled to move along a target trajectory 614 in a forward direction. At step 606, the vehicle 102 is controlled again to move along a target trajectory 616 in a reverse direction. Then, at step 608, the vehicle 102 is positioned in the target location 610.

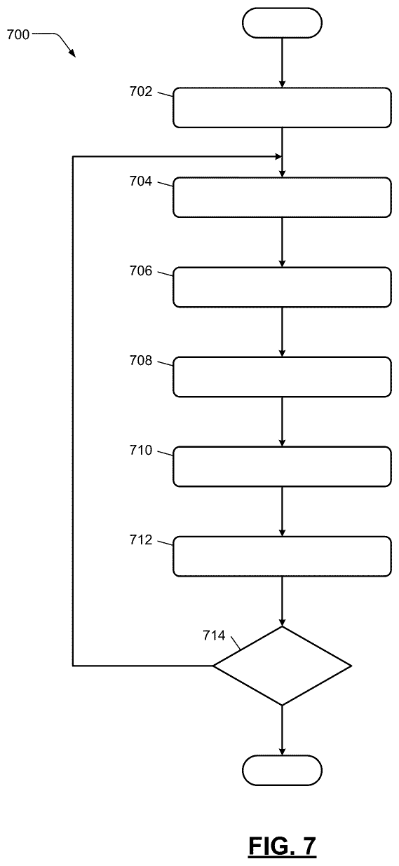

FIGS. 7-9 illustrate example control methods 700, 800, 900 employable by the vehicle system 100 of FIG. 1 for dynamically controlling bidirectional maneuvers of a vehicle, such as the vehicle 102. Although the example control methods 700, 800, 900 are described in relation to the vehicle system 100 of FIG. 1 including, for example, the control modules 104, 304 of FIGS. 1 and 3, any one of the control methods 700, 800, 900 may be employable by another suitable system and/or module.

As shown in FIG. 7, the control method 700 begins at 702 by receiving sensor data. For example, and as explained above, the control module 104, 304 may receive data from the sensor(s) 106 indicative of objects external to the vehicle 102. The control method 700 then proceeds to 704, where the control module 104, 304 determines a desired speed profile and a target trajectory base on the data (e.g., detected objects). In such examples, the desired speed profile and the target trajectory are determined to enable the vehicle 102 to make one or more maneuvers while avoiding the detect objects. Then, the control method 700 proceeds to 706, where the control module 104, 304 identifies a desired direction of vehicle travel based on the desired speed profile and/or the target trajectory, as explained above. The control method 700 then proceeds to 708.

At 708, the control module 104, 304 adapt a prediction control model to correspond to the desired direction of travel. For example, and as explained above, the control module 104, 304 may generate a matrix to represent the adapted prediction control model based on the desired speed profile and/or the target trajectory. The control method 700 then proceeds to 710, 712.

At 710, the control module 104, 304 generates a steering angle command using the adapted prediction control model, as explained herein. Then, at 712, the vehicle control module 108 then controls the vehicle 102 based on the steering angle command to maneuver the vehicle 102 along the target trajectory in the desired direction of travel, as explained above. Then, the control method 700 proceeds to 714.

At 714, the control module 104, 304 determines whether the vehicle 102 is at a target location, such as a target parking spot, a target location on a roadway, etc. This may be determined based on a known location of the vehicle 102. If no at 714, control returns to 704 as shown in FIG. 7. Otherwise, if yes at 714, control may end.

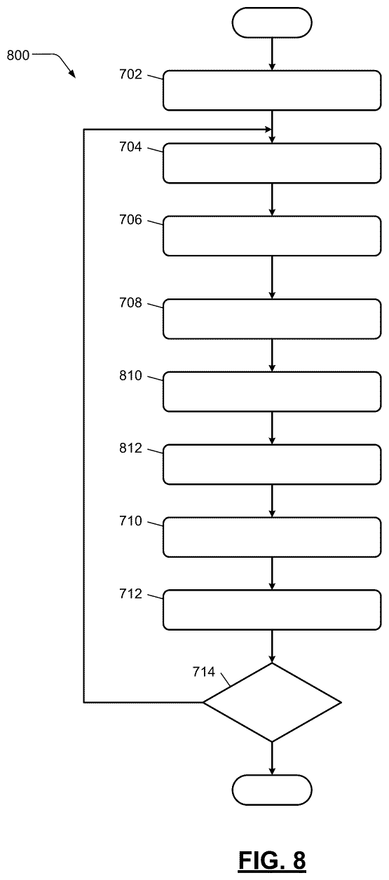

The control method 800 of FIG. 8 is similar to the control method 700 of FIG. 7 but includes additional steps. For example, and as shown in FIG. 8, the control method 800 begins at 702 of FIG. 7 and proceeds to 704, 706, 708 of FIG. 7 explained above. Then, the control method 800 proceeds to 810, 812.

At 810, the control module 104, 304 adapts one or more constraints for the adapted prediction control model from 708. At 812, the control module 104, 304 adapts one or more weights for the adapted prediction control model. In such examples, the control module 104, 304 may adapt the constraint(s) and/or the weight(s) based on the desired speed profile and/or the target trajectory, as explained above. The control method 800 then proceeds to 710, 712, 714 of FIG. 7 explained above.

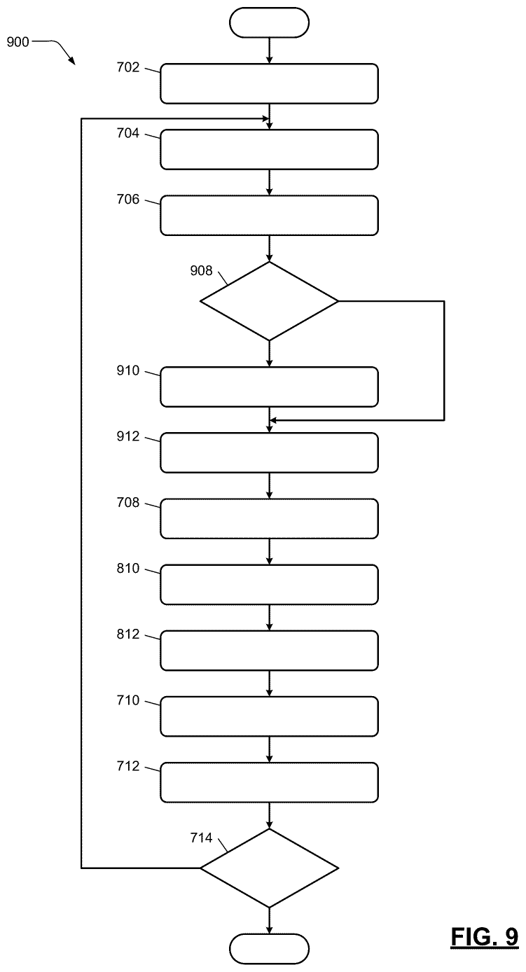

The control method 900 of FIG. 9 is similar to the control methods 700, 800 of FIGS. 7-8 but includes additional steps. For example, and as shown in FIG. 9, the control method 900 begins at 702 of FIG. 7 and proceeds to 704, 706 of FIG. 7 explained above. Then, the control method 900 proceeds to 908.

At 908, the control module 104, 304 determines whether a longitudinal velocity reference (Vₓ) is less than a defined threshold. If yes, the control method 900 proceeds to 910, where the control module 104, 304 latches the longitudinal velocity reference (Vₓ) to a defined value, such as the defined threshold or another suitable value. The control method 900 then proceeds to 912. If no at 908, the control method 900 proceeds to 912 and maintains the longitudinal velocity reference (Vₓ).

At 912, the control module 104, 304 determines reference states from the target trajectory and speed profile. For example, the control module 104, 304 can extract path segments and determine a reference yaw rate based on the longitudinal velocity reference (Vₓ), as explained above. Then, the control method 800 proceeds to 708, where the control module 104, 304 adapts a prediction control model to correspond to the desired direction of travel based on the reference yaw rate. The control method 800 then proceeds to 810, 812 of FIG. 8 explained above, and to 710, 712, 714 of FIG. 7 explained above.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, JavaScript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A vehicle system for dynamically controlling bidirectional maneuvers of a vehicle, the vehicle system comprising:
one or more sensors configured to detect one or more objects external to a vehicle;
a vehicle control module; and
a control module in communication with the one or more sensors and the vehicle control module, the control module configured to:
determine a desired speed profile and a target trajectory based on the detected objects;
identify a desired direction of travel for the vehicle based on at least one of the desired speed profile and the target trajectory;
dynamically adapt, based on at least one of the desired speed profile and the target trajectory, a prediction control model to correspond to the desired direction of travel; and
generate a steering angle command with the adapted prediction control model,
wherein the vehicle control module is configured control the vehicle based on the steering angle command to maneuver the vehicle along the target trajectory in the desired direction of travel.

2. The vehicle system of claim 1, wherein the control module is configured to:
determine a yaw rate reference for the vehicle;
determine a rate of change of a heading error based on the yaw rate reference; and
generate the steering angle command with the adapted prediction control model based on the rate of change of the heading error.

3. The vehicle system of claim 2, wherein the control module is configured to:
determine at least one of forward and reverse segments for the vehicle; and
determine the yaw rate reference for the vehicle based on the at least one of the forward and reverse segments.

4. The vehicle system of claim 3, wherein:
the target trajectory is a global frame target trajectory; and
the control module is configured to convert the global frame target trajectory into a vehicle frame trajectory and determine the at least one of the forward and reverse segments based on the vehicle frame trajectory.

5. The vehicle system of claim 2, wherein the control module is configured to:
determine a reference curvature for the vehicle based on the target trajectory; and
determine the yaw rate reference for the vehicle based on the reference curvature and a longitudinal velocity reference.

6. The vehicle system of claim 5, wherein the control module is configured to latch a value of the longitudinal velocity reference to a defined value in response to the longitudinal velocity reference being less than the defined value.

7. The vehicle system of claim 6, wherein the control module is configured to dynamically adapt at least one constraint for the adapted prediction control model based on at least one of the desired speed profile and the target trajectory.

8. The vehicle system of claim 7, wherein the control module is configured to select a defined value for the at least one constraint based on at least one of the desired speed profile and the target trajectory.

9. The vehicle system of claim 6, wherein the control module is configured to dynamically adapt at least one weight for the adapted prediction control model based on at least one of the desired speed profile and the target trajectory.

10. The vehicle system of claim 9, wherein the control module is configured to select a defined value for the at least one weight based on at least one of the desired speed profile and the target trajectory.

11. The vehicle system of claim 1, wherein the objects include at least one of a line marking and an object on a roadway.

12. The vehicle system of claim 1, wherein the desired direction of travel is a forward direction of the vehicle or a reverse direction of the vehicle.

13. The vehicle system of claim 12, wherein the prediction control model is stable during the forward direction of the vehicle and the reverse direction of the vehicle.

14. A vehicle system for dynamically controlling bidirectional maneuvers of a vehicle, the vehicle system comprising:
one or more sensors configured to detect one or more objects external to a vehicle;
a vehicle control module; and
a control module in communication with the one or more sensors and the vehicle control module, the control module configured to:
determine a desired speed profile and a target trajectory based on the detected objects;
identify a desired direction of travel for the vehicle based on at least one of the desired speed profile and the target trajectory;
dynamically adapt, based on at least one of the desired speed profile and the target trajectory, a prediction control model to correspond to the desired direction of travel;
dynamically adapt at least one constraint and at least one weight for the adapted prediction control model;
determine a yaw rate reference for the vehicle;
determine a rate of change of a heading error based on the yaw rate reference; and
generate a steering angle command with the adapted prediction control model based on the rate of change of the heading error,
wherein the vehicle control module is configured control the vehicle based on the steering angle command to maneuver the vehicle along the target trajectory in the desired direction of travel.

15. The vehicle system of claim 14, wherein the control module is configured to:
determine a reference curvature for the vehicle based on the target trajectory; and
determine the yaw rate reference for the vehicle based on the reference curvature and a longitudinal velocity reference.

16. The vehicle system of claim 15, wherein the control module is configured to latch a value of the longitudinal velocity reference to a defined value in response to the longitudinal velocity reference being less than the defined value.

17. A control method for dynamically controlling bidirectional maneuvers of a vehicle, the control method comprising:
detecting one or more objects external to a vehicle;
determining a desired speed profile and a target trajectory based on the detected objects;
identifying a desired direction of travel for the vehicle based on at least one of the desired speed profile and the target trajectory;
dynamically adapting, based on at least one of the desired speed profile and the target trajectory, a prediction control model to correspond to the desired direction of travel;
generating a steering angle command with the adapted prediction control model; and
controlling the vehicle based on the steering angle command to maneuver the vehicle along the target trajectory in the desired direction of travel.

18. The control method of claim 17, wherein:
the control method further comprises determining a reference curvature for the vehicle based on the target trajectory, determining a yaw rate reference for the vehicle based on the reference curvature and a longitudinal velocity reference, and determining a rate of change of a heading error based on the yaw rate reference; and
generating the steering angle command with the adapted prediction control model includes generating the steering angle command with the adapted prediction control model based on the rate of change of the heading error.

19. The control method of claim 18, further comprising latching a value of the longitudinal velocity reference to a defined value in response to the longitudinal velocity reference being less than the defined value.

20. The control method of claim 19, further comprising:
dynamically adapting at least one constraint for the adapted prediction control model based on at least one of the desired speed profile and the target trajectory; and
dynamically adapting at least one weight for the adapted prediction control model based on at least one of the desired speed profile and the target trajectory.
